(19) United States
(12) Patent Application Publication
(10) Pub. No.: US 2024/0394727 A1
(43) Pub. Date: Nov. 28, 2024

(54) SYSTEM AND METHOD FOR FACILITATING CIGARETTE SALES AND CIGARETTE TRACKING

(71) Applicant: K61 Blazer Investments (PTY) LTD, Gauteng (ZA)

(72) Inventor: Victor Albert Phillips, Gauteng (ZA)

(21) Appl. No.: 18/272,850

(22) PCT Filed: May 26, 2023
(86) PCT No.: PCT/IB2023/055410

§ 371 Date: Jul. 18, 2023

(30) Foreign Application Priority Data
Jul. 1, 2022 (ZA) 2022/07286
Sep. 6, 2022 (ZA) 2022/09914

(51) Int. Cl. G06Q 30/018; B65D 75/36; B65D 85/10; G06K 19/06; G06Q 20/20; G06Q 30/0601

(52) U.S. Cl. CPC G06Q 30/0185; B65D 75/367; B65D 85/10; G06Q 20/202; G06Q 30/0607; B65D 2575/3281; G06K 19/06037

(57) ABSTRACT

The present invention relates to a system and a method for facilitating either one of cigarette sales and cigarette tracking the system includes a package which presents a token or tokens, a user device, and a remote backend. The user device uses an input device, a first processor, a memory device and a first transceiver. The user device is typically a smart phone but may be any other device equipped with an input device which is able to access Global System for Mobile Communications (GSM) communications protocol. If the user device is not a smartphone, token may be an USSD alphanumeric code which is inputted using the input device's keyboard. The use of the device as described herein allows for a cheap, easy-to-manufacture product which also protects cigarettes contained within from degradation or damage.

### FIELD OF APPLICATION OF THE INVENTION

The present invention relates to a system and a method for facilitating either one of cigarette sales and cigarette tracking. The present invention also relates to a face seal blister package for cigarettes, more particularly for no more than four cigarettes.

### BACKGROUND TO THE INVENTION

The tobacco industry currently faces numerous challenges. Among these challenges is the fact that cigarette advertising is banned in most countries, which makes interacting with customers for marketing purposes difficult. This represents an unsolved problem in the field.

Further, almost 80% of cigarettes sold in developing countries (including many African nations) are sold individually from opened cigarette packages. Such individually sold cigarettes are referred to as “loose draws”. When cigarettes are sold as loose draws, the quality and authenticity may be questioned by a customer. Handing over loose cigarettes also holds the risk that it may not be the brand the customer has paid for. Additionally, the smoking experience of a loose cigarette often can be a disappointment due to numerous factors affecting the cigarette before it is even lit. Such factors include humidity, moisture, tobacco becoming stale, tobacco fallout, breakage, lack of protection against contamination, counterfeit brands operating under the guise of a respected brand, and unhygienic and unsanitary handling. All of these factors contribute to the perception that a loose cigarette is inferior to a packaged cigarette.

In addition to the above, the cigarette draw market is presently under-monitored and under-served, both in terms of products and marketing strategies. Statistically, an average smoker in this segment buys loose cigarettes 3 times daily, often from different retailers.

There is accordingly a need for systems and methods to allow cigarettes in the loose draw market to be tracked and monitored, and the consumers thereof catered to and marketed to.

There is a further need for systems and methods to facilitate the sale of small numbers of cigarettes at a time as branded products rather than commodity items, thereby allowing manufacturers to gain brand equity and avoid commodity price wars. These systems and methods should also ensure affordability of cigarettes for low-income consumers; provide extended shelf life to maintain freshness and hygiene; safeguard products against counterfeiting; improve the smoker's experience to encourage brand loyalty; and enable the implementation of a system for facilitating the tracking factory to the consumer. The system, in turn, would allow the identification of the end user for marketing and data mining purposes. It would additionally facilitate point-of-sale inspection to ensure recommended selling process are being adhered to. Such a system would assist in creating a new standard and changing the negative perception of loose cigarettes and would also ensure that taxes on cigarettes are appropriately paid for. The latter is especially relevant given that unpaid taxes on the lost transactions are estimated to equal over 8 billion US dollars in lost revenue per year.

It is noteworthy that the present invention also allows printing of any type of code, micro-code, graphic image or watermark with invisible ultraviolet and infrared inks; thereby ensuring brand product verification and advanced track-and-trace solutions. This technology can also be applied on the interior or external surfaces of the package of this invention.

### OBJECT OF THE INVENTION

Accordingly, it is an object of the invention to provide a system and a method for facilitating either one of cigarette sales and/or cigarette tracking for no more than four cigarettes, with which the applicant believes the aforementioned disadvantages may at least be alleviated or which may provide a useful alternative for the known systems and methods.

### SUMMARY OF THE INVENTION

According to a first aspect of the invention there is provided for a system for facilitating any one of cigarette sales and cigarette tracking, the system comprising:
a package for not more than four cigarettes, the package presenting a token comprising at least a first data set;
a user device comprising:
an input device for entering the first data set;
a processor in electronic communication with the input device for receiving the first data set and for processing the first data set for use in a first message; and
a first transceiver for transmitting the first message; and
a remote backend comprising:
a second transceiver for receiving the first message; and
a server in electronic communication with the second transceiver and configured to communicate a second message to the user device in response to the first message.

The second message may comprise at least one of: marketing data, promotional data, special offers, data relating to loyalty and rewards programs, contact information, Uniform Resource Locator (URL) information and data relating to outlets, customers and/or vendors.

The token may be any one of: an Alphanumeric String, a Barcode, a Static Quick Response (QR) Code, a Dynamic QR Code, an Unstructured Supplementary Service Data (USSD) Code and a Radio Frequency Identification tag (RFID tag).

The first data set may include a unique product identification code.

The user device may comprise a memory device in electronic communication with the first processor.

The first message may comprise data relating to a user of the device. The data relating to the user may comprise at least one of: data entered by the user on the device, and data stored on the memory device.

The data relating to the user may comprise at least one of: user contact data, user device data, device geographic location data, account data of the user, device usage data and biographic data relating to the user.

The system may comprise a point-of-sale device comprising:
a second input device for reading a second data set;
a second processor in electronic communication with the second input device for receiving the second data set and for processing the second data set for use in a third message; and
a third transceiver for transmitting the third message.

The server may be configured to communicate a fourth message to the point-of-sale device in response to the third message.

The second data set may be identical to the first data set.

According to a second aspect of the invention, there is provided for a face seal blister package for no more than four cigarettes, the package comprising:
a body comprising a planar face defining an elongate blister-like cavity having a longitudinal axis, the cavity having an elongate mouth in the planar face and the longitudinal axis being parallel to the planar face;
a film seal for removably covering the elongate mouth; and
a token presented by the package, the token comprising a first data set.

The film seal may be adhered to the body.

The film seal may be adhered to the body by any one or more of: adhesive bonding, solvent bonding, heat bonding and mechanical fastening.

The token may be any one of: an Alphanumeric String, a Barcode, a Static Quick Response (QR) Code, a Dynamic QR Code, an Unstructured Supplementary Service Data (USSD) Code and a Radio Frequency Identification tag (RFID tag).

The first data set may include a unique product identification code.

The body may be made of any one of: plastic, paper, a derivative of plastic and a derivative of paper.

The body may be transparent or translucent.

The film seal may be made of any one of: plastic, paper, metal foil and cardboard paper.

The metal foil may be an aluminium foil or a plastic-coated aluminium foil.

The plastic may be selected from the group comprising: polyethylene, polyethylene terephthalate, polyvinyl chloride, polypropylene, polystyrene, polycarbonate, polyamide, polylactic acid and acrylic.

A plurality of packages may be joined into a strip.

The token may be printed anywhere on the interior or exterior surface of the translucent or transparent body, the printing on the inside of the transparent body being intended to prevent possible tampering of the token.

The package may be used in the system for facilitating either one of cigarette sales and cigarette tracking.

According to a third aspect of the invention, there is provided for a method for facilitating either one of cigarette sales and cigarette tracking, the method comprising, at a backend:
processing a first message received from a user device, the first message comprising at least a first data set extracted from a token presented by a package for not more than four cigarettes; and
compiling and transmitting to the user device a second message in response to the first message.

The second message may comprise at least one of: marketing data, promotional data, special offers, data relating to loyalty and rewards programs, contact information, Uniform Resource Locator (URL) information and data relating to outlets and vendors.

The token may be any one of: an Alphanumeric String, a Barcode, a Static Quick Response (QR) Code, a Dynamic QR Code, an Unstructured Supplementary Service Data (USSD) Code and a Radio Frequency Identification tag (RFID tag).

The first message may comprise data relating to a user of the device. The data relating to the user may comprise at least one of: data entered by the user on the device, and data stored on the memory device.

The data relating to the user may comprise at least one of: user contact data, user device data, device geographic location data, account data of the user, device usage data and biographic data relating to the user.

### BRIEF DESCRIPTION OF THE ACCOMPANYING DIAGRAMS

The invention will now further be described, by way of example only, with reference to the accompanying diagrams wherein:

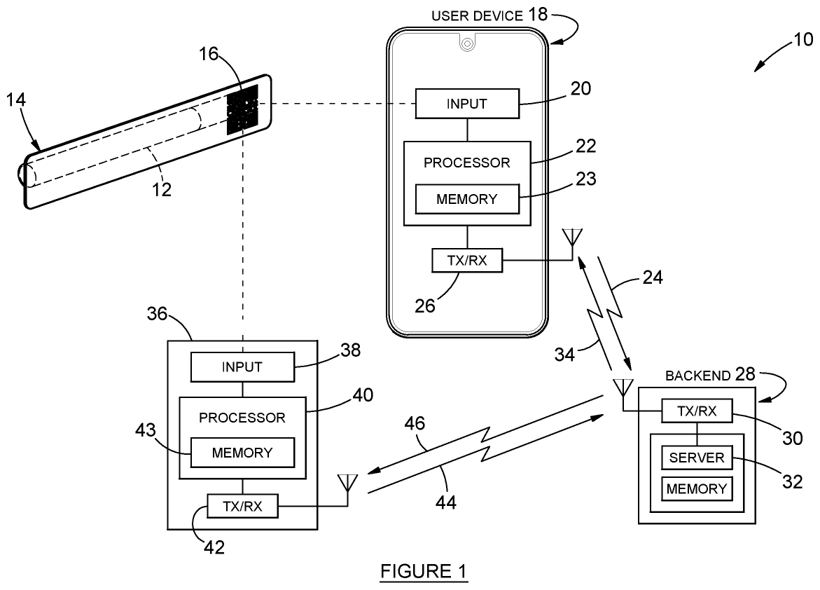

FIG. 1 is a diagrammatic representation of a system for facilitating either one of cigarette sales and cigarette tracking;

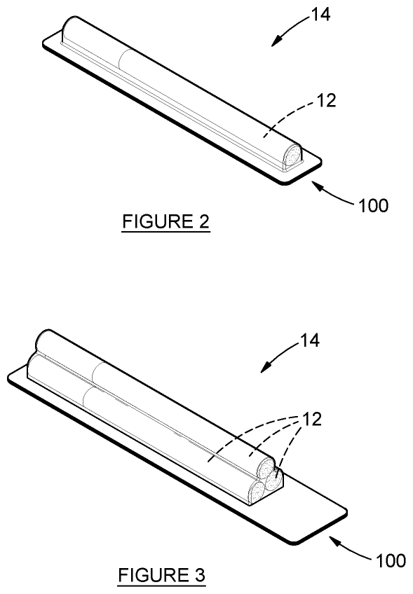

FIG. 2 is a first perspective view of a first embodiment of a blister seal package for no more than four cigarettes;

FIG. 3 is a first perspective view of a second embodiment of the blister seal package for no more than four cigarettes;

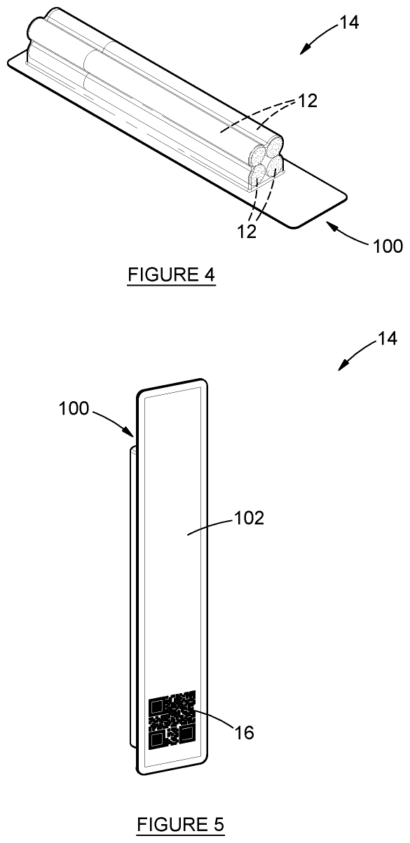

FIG. 4 is a first perspective view of a third embodiment of the blister seal package for no more than four cigarettes;

FIG. 5 is a second perspective view of the blister seal package for no more than four cigarettes, the second perspective view showing a token presented by the package;

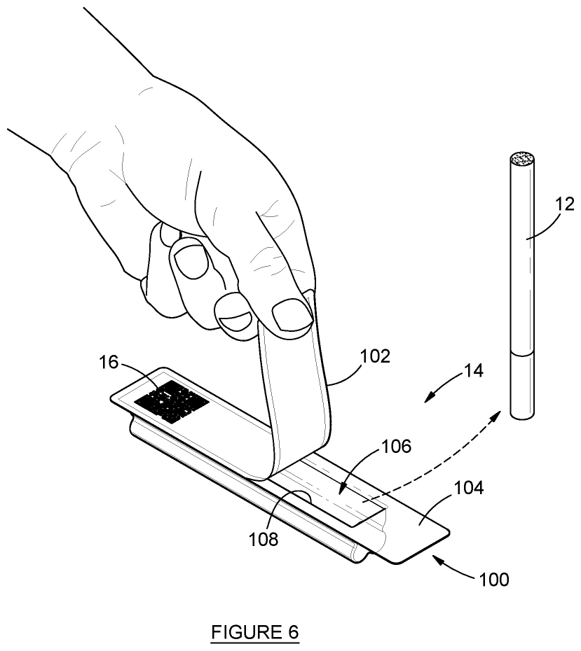

FIG. 6 is a perspective view of the blister seal package for no more than four cigarettes being opened by a user; and

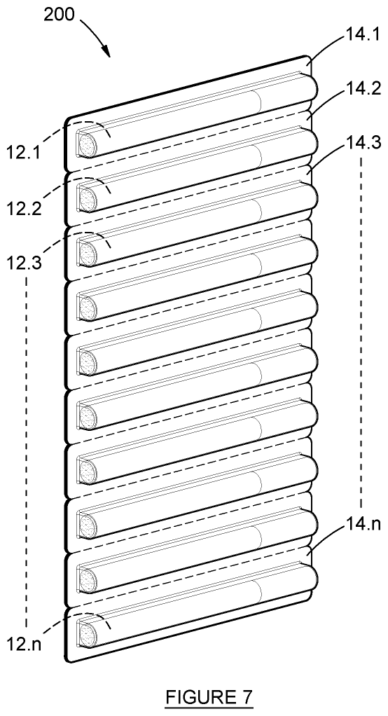

FIG. 7 is a perspective view of a plurality of blister seal packages for no more than four cigarettes, where the packages are joined.

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

### DESCRIPTION OF EXAMPLE EMBODIMENTS OF THE INVENTION

An example embodiment of a system for facilitating cigarette sales and tracking is generally designated by the reference numeral 10 in FIG. 1.

Referring to FIG. 1, the system 10 for facilitating the sale and tracking of cigarettes 12 comprises a package 14 which presents a token or tokens 16 (in this regard note that multiple tokens can be adhered to a single package, for example an USSD code printed on the inside of the plastic translucent or transparent blister; together with a RFID tag; and a Dynamic QR Code as shown in 16), a user device 18, and a remote backend 28. The user device 18 comprises an input device 20, a first processor 22, a memory device 23 and a first transceiver 26. The user device 18 is typically a smart phone but may be any other device equipped with an input device which is able to access Global System for Mobile Communications (GSM) communications protocol. If the user device is not a smartphone, token 16 may be an USSD alphanumeric code which is inputted using the input device's keyboard. The remote backend 28, typically the cigarette distributor's computer, comprises a second transceiver 30 and a server 32.

The package 14 (best shown in FIGS. 2 to 4) is a face seal blister package which is sized to contain not more than four cigarettes. Again referring to FIG. 1, the token 16 comprises at least a first data set (not shown). The input device 20 enables a user (not shown) to enter the first data set into the user device 18. The input device 20 is typically a keypad or a camera of the device 18. The input device 18 and the first processor 22 are in communication with each other. When the first data set is entered into the user device 18, the first processor 22 receives the first data set and processes it for use in a first message 24. Then, the first message 24 is transmitted by the transceiver 26 to the remote backend 28. The second transceiver 30 receives the first message 24. The second transceiver 30 and the server 32 are in electronic communication with each other. The server 32 is configured to communicate a second message 34 back to the user device 18 in response to the first message 24.

In the embodiment shown, the token 16 is a Quick Response (QR) code. Preferably, the token 16 is a dynamic QR code, but it may also be a static QR code or a USSD alphanumeric code. In other embodiments (not shown), the token 16 may be any one or more, alone or in combination, of an Alphanumeric String, a Barcode, a Static Quick Response (QR) Code, a Dynamic QR Code, an Unstructured Supplementary Service Data (USSD) Code and a Radio Frequency Identification tag (RFID tag). In the embodiment where the token 16 is a QR code, the first data set is encoded or embedded in the QR code. The first data typically comprises a unique product identification code for individually identifying the package 14. The first data may further comprise at least one of internet protocol (IP) data and data relating to a Uniform Resource Locator (URL) for directing a smart phone application (app) to a specific website.

The first message 24 may comprise data relating to the user, which is typically at least one of data entered by the user on the device 18 and data stored on the memory device 23. Examples of the data relating to the user are the following: user contact data, user device data, device geographic location data, account data of the user, device usage data and biographic data relating to the user. The second message 34 may comprise at least one of marketing data, promotional data, special offers, data relating to loyalty and rewards programs, contact information, Uniform Resource Locator (URL) information and data relating to outlets and vendors.

Still referring to FIG. 1, the system 10 may also comprise a point-of-sale device 36. In such a case, the token 16 comprises a second data set. The point-of-sale 36 device comprises a second input device 38, a second processor 40, a third transceiver 42 and a memory device 43. The second input device 38 enables a second user to enter the second data set into the second input device, which may be point-of-sale device 36. The second data set may be identical to the first data set The second input device 38 and the second processor 40 are in communication with each other. The second input device 38 is typically a barcode scanner. The second input device 38 may also be a camera system or a keypad. When the second data set is entered into the point-of-sale device 36, the second processor 40 receives the second data set and processes it for use in a third message 44. Then, the third message 44 is transmitted by the third transceiver 42 to the backend 28. In such a case, the server 32 is configured to communicate a fourth message 46 back to the point-of-sale device 36 in response to the third message 44.

In an embodiment (not shown) where the token 16 is an alphanumeric code, the first data set can be entered into the user device 18 by using the keypad. In such an embodiment the first message 24 is transmitted via a cellular network using an Unstructured Supplementary Service Data (USSD) protocol. The USSD protocol allows a real-time connection between the user device 18 and a mobile network operator's computer dedicated to USSD transactions during a USSD session. In such an embodiment, the backend 28 comprises at least one of the mobile network operator's computer and a computer linked thereto.

An example embodiment of a face seal blister package according to the invention is generally designated by reference numeral 14 in FIGS. 1 to 7.

As best shown in FIG. 6, the package 14 comprises a body 100, a film seal 102 and a token 16. The body 100 is preferably made of a transparent or translucent material such as plastic. The body 100 comprises a planar face 104 which defines an elongate blister-like cavity 106. The cavity 106 has an elongate mouth 108 and a longitudinal axis (not shown). The longitudinal axis is parallel to the planar face 104. The cavity 106 can be sized to receive not more than four cigarettes. In use, the film seal 102 removably covers the elongate mouth 108. In the embodiment shown, the token 16 is printed anywhere on the interior or exterior of the film seal 102. In other embodiments (not shown), the token 16 is printed anywhere on the interior or exterior of the body 100. Printing on the interior of the body, which printing is viewed from the outside, can assist alleviate tampering with the printed matter.

In further alternative embodiments the body 100 may be made of one or more materials such as paper or plastic or any one or more derivates thereof.

The film seal 102 is preferably made of plastic-coated aluminium foil or other material such as paper, plastics or derivates thereof. The film seal 102 is adhered to the body using adhesives. During manufacture, a cigarette 12 is placed within the cavity 106, and then covered by the film seal 102

The film seal 102 may be resealable, which will allow the package 14 to be opened and closed multiple times.

During use, removal of the film seal 102 from the body 100 exposes the planar face and allows the user to withdraw a cigarette.

As best shown in FIGS. 2 to 4, the body 100 can be shaped to contain either one, two, three or four cigarettes 12.

Referring to FIG. 7, a plurality of packages (14.1 to 14.n) can be joined in a strip 200. The packages (14.1 to 14.n) can then be separated from one another when sold to a consumer. The strip 200 defines perforations between the packages (14.1 to 14.n) to facilitate removal of at least one of the packages (14.1 to 14.n) from the strip.

The use of package 14 as described herein allows for a cheap, easy-to-manufacture product which also protects the cigarette or cigarettes 12 contained within from degradation or damage. It also provides for multiple configurations of product which can be made using a common production process and tooling, as individual cavities can be combined into strips, which can then be cut and stacked in various ways.

Taken together, the system, method and packaging therefor provide a number of advantages. These include waterproof packaging, sealed-in freshness, protection against breakage, hygiene, eliminating tobacco falling out, product visibility and brand visibility. The packaging can be made recyclable to support sustainability. The packaging is innately tamper-proof, preventing retailers from replacing original cigarettes with cheaper alternatives or otherwise counterfeiting the product. The packaging also eliminates the need for cashiers or vendors to touch the product directly.

The collection and tracking of the first data set facilitates cigarette tracking all the way from the factory to the end user (because each packet is uniquely coded). Therefore, direct scanning and tracking of products is enabled, allowing retailers to use the barcode or the Dynamic Inventory QR Code system for stock control. Finally, the system enables collection of taxes due at the final point of sale.

In an environment where conventional marketing approaches are outlawed, current marketing and promotional strategies have proven less than successful. These have consisted mainly of secondary branding exercises such as sponsorships, prize giveaways, giveaways of branded items and the like. These are generally held to have provided no measurable results aside from achieving brand awareness. The system of the present invention is held to overcome these issues by allowing a direct line of communication between customer and brand-holder. Further, in an environment of flat or declining sales, organic sales growth can only be achieved at the expense of the market share of other brand holders. The system and packaging of the present invention is accordingly expected to provide an advantage to brand-holders attempting to increase their market share.

The ability to uniquely identify every package, and connect this information to a specific consumer, provides a platform for embedded marketing and promotional opportunities, and detailed consumer statistics. In understanding the consumer holistically, a brand-holder can ensure conversion and retention. In addition, the system and package of the present invention provides the ability to communicate with the end user using the package token. This may be done either using an app on a user's phone, or via the alphanumeric code displayed on the package for non-smartphone users. Building of a customer profile based on brand preference, geographic location, age, gender, income etc allows marketing, promotional offers, prize draws, rebates, discounts, loyalty programs and the like to be targeted and conducted directly to users.

1. A system for facilitating either one of cigarette sales and cigarette tracking, the system comprising:
a package for not more than four cigarettes, the package presenting a token comprising at least a first data set, wherein the first data set includes a unique product identification code;
a user device comprising:
an input device for entering the first data set;
a processor in electronic communication with the input device for receiving the first data set and for processing the first data set for use in a first message; and
a first transceiver for transmitting the first message;
a memory device in electronic communication with the first processor; and
a remote backend comprising:
a second transceiver for receiving the first message; and
a server in electronic communication with the second transceiver and configured to communicate a second message to the user device in response to the first message, wherein the second message comprises at least one of marketing data, promotional data, special offers, prize draws, data relating to loyalty and rewards programs, contact information, Uniform Resource Locator (URL) information and data relating to outlets, vendors, product distributor and/or product manufacturer.

2. The system of claim 1 wherein the token is any one of: an Alphanumeric String, a Barcode, a Static Quick Response (QR) Code, a Dynamic QR Code, an Unstructured Supplementary Service Data (USSD) Code and a Radio Frequency Identification tag (RFID tag).

3. The system of claim 1 wherein the first message comprises data relating to a user of the device, the data relating to the user comprising at least one of: data entered by the user on the device, data stored on the memory device, user contact data, user device data, device geographic location data, account data of the user, monthly income, gender, device usage data and biographic data relating to the user.

4. The system of claim 1 wherein the system further comprises a point-of-sale device comprising:
a second input device for reading a second data set;
a second processor in electronic communication with the second input device for receiving the second data set and for processing the second data set for use in a third message, wherein the second data set is identical to the first data set; and
a third transceiver for transmitting the third message.

5. The system of claim 4, wherein the server is further configured to communicate a fourth message to the point-of-sale device in response to the third message.

6. A face seal blister package for no more than four cigarettes, the package comprising:
a body comprising a planar face defining an elongate blister-like cavity having a longitudinal axis, the cavity having an elongate mouth in the planar face and the longitudinal axis being parallel to the planar face;
a film seal for removably covering the elongate mouth, wherein the film seal is adhered to the body by any one of: adhesive bonding, solvent bonding, heat bonding and mechanical fastening; and
a token presented by the package comprising a first data set that may be an unique product identification code, wherein the token is any one of: an Alphanumeric String, a Barcode, a Static Quick Response (QR) Code, a Dynamic QR Code, an Unstructured Supplementary Service Data (USSD) Code and a Radio Frequency Identification tag (RFID tag).

7. The package of claim 6 wherein the body is transparent or translucent and is made of any one of: a metal foil, an aluminium foil, a plastic-coated aluminium foil, a plastic, a paper, derivatives of plastic and/or of paper or a combination of any of the foregoing.

8. The package of claim 6 wherein a plurality of packages is joined into a strip.

9. The package of claim 6 wherein the token is printed anywhere on the surface of the translucent or transparent body, anywhere on the surface of the film seal, anywhere on the surface of the metal foil, on the interior or the exterior surface; or on both surfaces simultaneously.

10. A method for facilitating either one of cigarette sales and cigarette tracking, the method comprising, at a backend:
processing a first message received from a user device, the first message comprising at least a first data set extracted from a token presented by a package for not more than four cigarettes, wherein the first message further comprises data relating to a user of the device, the data relating to the user comprising at least one of: data entered by the user on the device, and data stored on the memory device, user contact data, user device data, device geographic location data, user income data, user gender data, user seasonal purchase data, user brand preference data, user cigarette consumption data, account data of the user, device usage data and biographic data relating to the user; and
compiling and transmitting to the user device a second message in response to the first message, wherein the second message comprises at least one of: marketing data, promotional data, special offers, data relating to loyalty and rewards programs, contact information, Uniform Resource Locator (URL) information and data relating to outlets and vendors.
